(19) United States
(12) Patent Application Publication
(10) Pub. No.: US 2007/0271370 A1
(43) Pub. Date: Nov. 22, 2007

(54) CONTROLLED STUDY OF SPONSORED SEARCH

(75) Inventor: Thomas A. Kehl, Palo Alto, CA (US)

Correspondence Address: BEYER WEAVER LLP, P.O. BOX 70250, OAKLAND, CA, 94612-0250, US

(73) Assignee: YAHOO! INC., Sunnyvale, CA (US)

(21) Appl. No.: 11/419,107

(22) Filed: May 18, 2006

(51) Int. Cl. G06F 15/173

(52) U.S. Cl. 709/224

(57) ABSTRACT

A computer system is operated to study effects on users of an advertisement under study. Actions by the users result in displaying information correspond to the actions of the users and of advertisements corresponding to the actions by the user and/or to the displayed information. In response to a display event resulting from action by a particular user, corresponding to the advertisement under study, the information corresponding to that action is caused to be displayed to that particular user. The advertisement under study is selectively caused to be displayed to that particular user in association with the information corresponding to that action, based on information that is substantially independent of that action and of the particular user. Later, indications relative to the subject matter of the advertisement under study are elicited from that particular user. The elicited indications for the plurality of particular users are processed to analyze the effect, collectively, of the advertisement under study.

### BACKGROUND

“Sponsored Search” is a system provided by Yahoo! to deliver relevance-targeted paid advertisements as part of the search results, in response to a search query. Measuring the “clicks” on the paid advertisements can provide a measure, in some sense, of the effectiveness of the paid advertisements. Reliable measurement of less direct effects of the paid advertisements can be more elusive, however.

### SUMMARY

A method is provided to operate a computer to study effects on users of an advertisement under study. Actions by the users result in displaying information corresponding to the actions of the users and of advertisements corresponding to the actions by the user and/or to the displayed information.

For each of a plurality of particular users, in response to a display event resulting from action by that particular user, corresponding to the advertisement under study, the information corresponding to that action is caused to be displayed to that particular user. In addition, the advertisement under study is selectively caused to be displayed to that particular user in association with the information corresponding to that action, based on information that is substantially independent of that action and of the particular user.

At a time later than the time at which the information is caused to be displayed to that particular user, indications relative to the subject matter of the advertisement under study are elicited from that particular user. The elicited indications for the plurality of particular users are processed to analyze the effect, collectively, of the advertisement under study.

### BRIEF DESCRIPTION OF THE FIGURES

FIG. 1 is a flowchart illustrating processing to provide controlled advertisement display (e.g., in response to a sponsored search) such that attitudinal metrics may be statistically determined toward an advertisement under study.

FIG. 2 is a flowchart illustrating processing to glean the attitude of users toward subject matter of an advertisement under study.

FIG. 3 illustrates a simplistic timeline to provide an example overview of the processing illustrated in FIGS. 1 and 2.

FIG. 4 illustrates a system in which the method steps of the FIG. 1 and FIG. 2 flowcharts may operate.

### DETAILED DESCRIPTION

In accordance with an aspect, methodology is provided to statistically determine the impact (e.g., branding) of search and other targeted online advertising. Such determinations are sometimes referred to as “attitudinal metrics.”

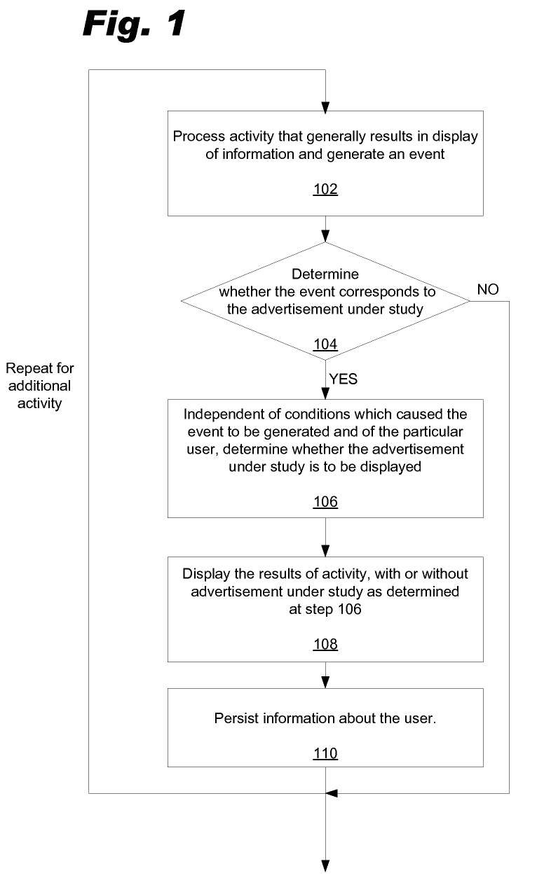

FIG. 1 is a flowchart illustrating a methodology in support of such a determination, for a particular item of advertising. Turning now to FIG. 1 in detail, reference numeral 102 refers to processing some activity that generally results in display of information (such as, for example, search results or web content), and that also results in advertising being displayed based on an advertising display “event” that nominally indicates the advertising to display. Such an event may be, for example, a result of “sponsored search” processing by which a user requests a search engine to generate search results based on search query keywords provided by the user. In addition to causing search results to be displayed, the search engine (or software associated with or otherwise in communication with the search engine) nominally also causes one or more sponsored advertisements to be displayed to the user based on the search query keywords provided by the user. Another event may be to nominally cause contextual advertising to be displayed, in which advertising is displayed on a web page based on the content of the web page. Typically, the advertisements are displayed visually, although other examples include “display” for sensory perception other than visual.

At step 104, it is determined if the event generated at step 102 is an event that corresponds to actions of the user that a particular advertisement (“advertisement under study”), the effect of which it is desired to statistically determine. That is, for example, display of the particular advertisement may nominally result from a search query using keywords on which an advertiser has bid using, for example, the Sponsored Search feature provided by Yahoo!. If so, then processing continues at step 106. Otherwise, processing returns to step 102, for additional activity.

At step 106, it is determined, independent of conditions which caused the event to be generated at step 102 and independent of the particular user as well, whether the advertisement under study is to be displayed. That is, in general, users are not predetermined to be part of an experimental group or of a control group. Users to whom the advertisement under study is determined to not be displayed at step 106 become part of a control group, whereas users to whom the advertisement under study is determined to be displayed at step 106 become part of an experimental group.

There are many different ways in which the determination of step 106 may be made. One way includes considering time slices, such that events generated (step 102) during an experimental period are determined to result in display of the advertisement under study, but events generated during a “control” time period are determined instead to not result in display of the advertisement under study. For example, the time slices may be such that events occurring on Monday, Wednesday and Friday may be deemed to occur during the experimental period, whereas events occurring on Tuesday, Thursday and Saturday may be deemed to occur during the control period. The time periods are preferably allocated such that any differences between the impression of users who view the advertisement under study and of users who do not view the advertisement under study substantially relate, to the extent possible, to the viewing or not viewing the advertisement under study and not to other factors, related to allocating the time periods. In some examples, the time periods may not even be allocated in advance but, rather, may be allocated randomly or pseudo-randomly as the events occur.

In one example, a configuration of the system determines the advertisements to display (e.g., as part of a Sponsored Search “bidding” system). The configuration of the system is selectively modified, independently of the actions of the users, such that bidding for the advertisement under study is turned on during some time periods (e.g., so that the processing of the Sponsored Search is such that the search keywords that cause the event to be generated at step 102 result in display of the advertisement under study during those time periods). On the other hand, the configuration is selectively modified such that bidding for the advertisement under study is turned off during some other time periods (e.g., so that the processing of the Sponsored Search is such that the keywords that cause the event to be generated at step 102 do not result in display of the advertisement under study during those other time periods). The turning on and off of bidding may be according to a regular pattern or, for example, may be in a random or pseudo-random manner. A similar processing of turning bidding on and off, for the keywords that correspond to the advertisement under study, may be employed with advertising that is based on the content of a displayed web page. In this example, then, the determination at step 106 is not so much an explicit determination of whether to cause or not cause display of the advertisement under study but, rather, is an implicit determination based on the status of the configuration as the event is generated or processed.

At step 108, the results of the activity (i.e., the activity processed at step 102, that generally results in display of advertising) is displayed, with or without the advertisement under study in accordance with the determination at step 106. In other words, for example, if the activity is a search query, then at step 108, the search results based on the search query are displayed, with or without the advertisement under study as appropriate to whether the searching user is determined at step 106 to be in the control group or in the experimental group.

At step 110, information about the user is persisted. The persisted information is raw information usable to determine that the user is one of the users in the study and whether the user is in the control group or in the experimental group. That is, at a later time, the user will be provided a survey to glean the user's attitude toward the subject matter of the advertisement under study. Using the persisted information, it can be later determined in the first place which users generally are users in the study and, further, the user's responses can be considered as control group responses or experimental group responses, as appropriate.

In some examples, rather than having only two groups (a “two bucket test”), one or more additional groups may be displayed different advertisements (e.g., some with text only and some with graphics), such that additional statistical conclusions can be drawn based upon the survey results. As a practical matter, there may be a requirement for higher volume of users who will perform the activity that nominally results in display of the advertisement under study (step 104), so that a sufficient amount of survey data can be gathered in a reasonable amount of time. In one example, it is considered that each bucket should be allocated at least four hundred survey respondents in order for the comparison between the survey results to be comfortably statistically significant.

There are a number ways to persist the information about the user (step 11O). For example, the user may have “logged on” such that the user is readily identifiable and information about the time slice in which an advertisement display event occurs relative to the user may be persisted in a centralized fashion (i.e., associated with the user's “account”). As another example, a browser cookie may be associated with the user using, for example, well-known mechanisms to associate information with the user in a distributed manner. The browser cookie will be accessible to match the survey results to the time slice in which the display event, corresponding to the user's actions, was generated.

Turning again to practical considerations with respect to duration of the experiment, it may be desirable to keep the experiment short—for at least several reasons. One reason is that the longer the experiment runs, the more chance there is that a particular user will fall into more than one bucket (e.g., by doing a search at multiple times, each falling within a time slice of a different bucket), or even fall into the same bucket multiple times. Such users may be considered to be “impure” such that survey responses from those users are not considered or are analyzed separately. In addition, some systems on which the experiment may be run employ a competitive bidding process to match sponsored advertisements with content (e.g., keywords provided in a search query, or content appearing on a displayed web page). Since the selective display of the advertisement under study is typically set up based on a priori use of certain keywords, the longer the data collection runs, there more likelihood that there will be a bidding war for those certain keywords.

Whatever the duration considerations, it is noted that the processing of FIG. 1 is repeated for a plurality of event triggering actions. For example, the “experiment” may be set to run for a particular number of days during which, using the search engine, for example, many searches will be run using the query keywords that trigger events relative to the experiment.

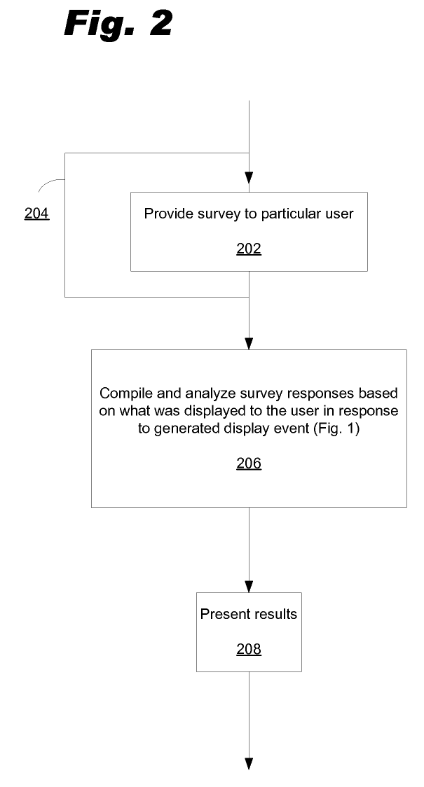

Having described with reference to FIG. 1 how the advertisement display environment is regulated with respect to users, we now describe with reference to FIG. 2 how data is gathered to glean the attitudes of users toward the subject matter of the advertisement under study. In particular, FIG. 2 is a flowchart illustrating processing to glean the attitudes of users toward the subject matter of the advertisement under study. The users referred to in FIG. 2 are users who are either in the control group or the experimental group (using the two-bucket example for ease of explanation).

For example, users—both those in the control group and those in the experimental group—are designated (e.g., based on the persisted information—step 110 of FIG. 1) so that the user can be served an “invisible advertisement” on a subsequent web page viewing (typically, when viewing a web page under the control of the advertisement displayer), where the invisible advertisement causes a survey invitation to be launched. Other methods may be utilized to designate the users to whom to provide a survey.

Step 202 of the FIG. 2 flowchart represents the processing to provide the survey to a particular user, who is one of the users designated to whom to provide a survey. The survey may contain, for example, questions organized into a number of sections such as “Unaided Awareness”; “Aided Awareness & Familiarity”; “Brand Consideration”; Purchase Intent”; “Brand Leadership”; “Strategic Message Association”; and “Seeing Search Results and Others.” In addition, some survey questions may be include to collect demographic information about the user, such as whether the user is the primary decision maker in his/her household for the product(s) of the brand, and what is the user's gender, age, income and location.

Moreover, the arrow 204 in the FIG. 2 flowchart represents repeating step 202 for a plurality of the particular users. At step 206 (reached, for example, when the survey period is concluded), the answers to the survey are divided into two groups, those answers provided by users in the control group and those answers provided by users in the experimental group. (Where there are a different number of buckets than two, the answers may be divided into a different number of groups.) The answers are compiled and analyzed. Thus, for example, statistics are compiled to compare, between the users in the control group and users in the experimental group(s), opinions and/or attitudes of those users toward the subject matter of the advertisement under study.

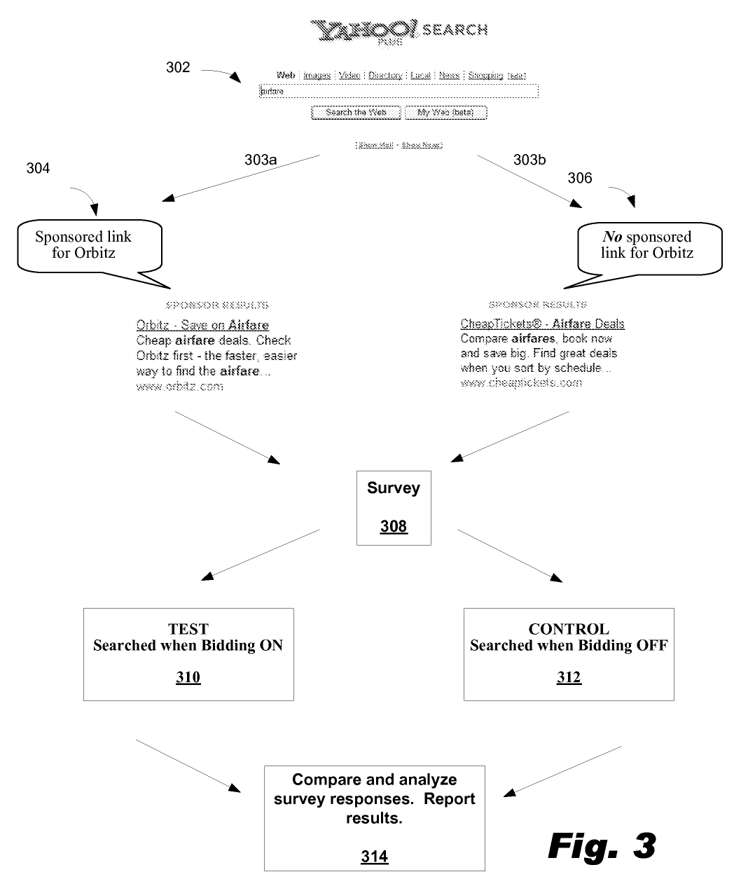

FIG. 3 illustrates a simplistic timeline to provide an overview to the process discussed above, with reference to FIGS. 1 and 2. At 302, the user enters a search query via a search engine interface. In this case, the search query includes only the keyword “airfare,” and the system is configured such that this keyword generates an event that corresponds to the advertisement under study. That is, the system is set up so that the search query keyword “airfare” results in selective display of the advertisement under study.

Arrow 303a and 303b respectively indicate a determination (e.g., at step 106 of the FIG. 1 flowchart) to display the advertisement under study (303a) and to not display the advertisement under study (303b). Reference numeral 304 represents the advertisement under study being displayed, whereas reference numeral 306 indicates the advertisement under study not being displayed.

After the survey 308 is taken, the survey responses are divided into buckets. In the FIG. 3 example, there are two buckets—an experimental bucket 310 and a control bucket 312. Finally, at 314, the responses are compared and analyzed, and the results are reported or are otherwise made available for inspection.

As an example, the responses and corresponding behavioral information may be analyzed to answer the following questions:
Was there a difference in click rates between the buckets
How often and in what time frames the respondents and non-respondents searched on the key terms
How often in the previous weeks the respondents and non-respondents searched on the key words
What is the average time between exposure to the sponsored links and survey completion?
What is the average time between exposure to display ads and survey completion?
What was the average link position in the search results for each bucket?
Which URLs in the search results did respondents click?

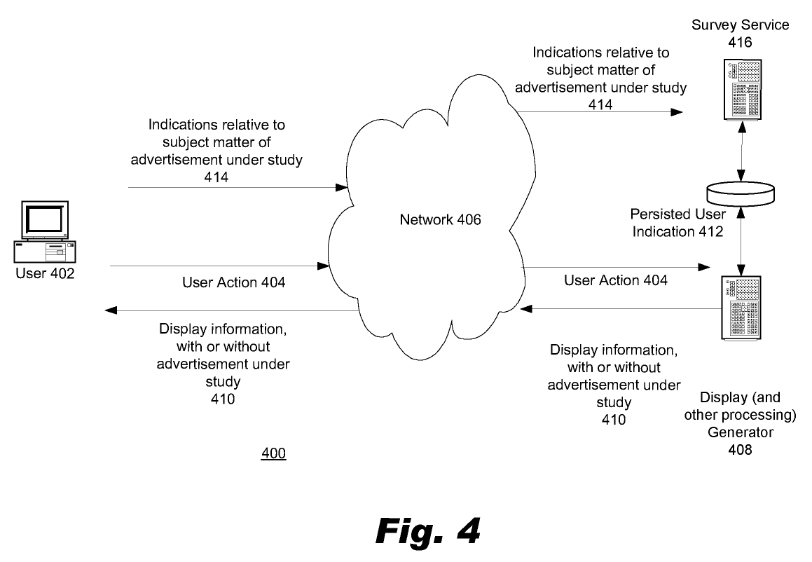

FIG. 4 is a block diagram illustrating a system in which the method steps of the FIG. 1 and FIG. 2 flowcharts may operate. Since the method has been described in detail above, in the discussion of FIG. 4, some of the method processing is discussed in a simplified manner. In addition, while some computers are shown in FIG. 4 as a single machine, the computers may be distributed computing devices, and are not necessarily even in the same location.

Referring specifically to FIG. 4, one client computer 402 is shown although, in practice, there are a plurality of such client computers. A signal 404 indicative of a user action is provided from the client computer 402, via a network 406, to a display generator 408. The display generator 408 generates a signal 410 to cause the display, on the appropriate client computer 402 (the computer from which the signal indicative of the user action originated), of information corresponding to the user action.

The information is caused to be displayed either with or without, as discussed in detail above, the advertisement under study. Signals indicative of the user actions are provided to the display generator 408, via the network 406, from a plurality of client computers. A store 412 is maintained to persist user indications, relative to the plurality of client computers, as also discussed in detail above.

Indications 414 relative to subject matter of advertisement under study are elicited, and provided, via the network 406, to a survey service 416. The survey service 416 processes the indications, in view of the user indications persisted in the store 412, to analyze the effect, collectively, of the advertisement under study.

It can be seen, then, for example, that measurement (via statistical analysis) can be used to determine the indirect effects of paid advertising.

What is claimed is:

1. A computer-implemented method to study effects on users of an advertisement under study, wherein actions by the users result in displaying information corresponding to the actions of the users and of advertisements corresponding to the actions by the user and/or to the displayed information, the method comprising:
for each of a plurality of particular users,
in response to a display event resulting from action by that particular user, corresponding to the advertisement under study, causing display to that particular user of the information corresponding to that action;
selectively causing the advertisement under study to be displayed to that particular user in association with the information corresponding to that action, based on information that is substantially independent of that action and of the particular user;
at a time later than the time at which the information is caused to be displayed to that particular user, eliciting from that particular user indications relative to the subject matter of the advertisement under study;
processing the elicited indications for the plurality of particular users to analyze the effect, collectively, of the advertisement under study.

2. The method of claim 1, further comprising:
modifying a configuration substantially independently of the actions of the particular users;
wherein the information upon which the step of selectively causing the advertisement under study to be displayed includes the configuration being modified.

3. The method of claim 2, wherein:
the configuration is a keyword bidding configuration, that associates an advertisement for display with the keywords corresponding to the advertisement under study.

4. The method of claim 1, wherein:
the method further comprises, for each of the particular users, based on the action by that particular user corresponding to the advertisement under study, persisting an indication of that user, including information usable to determine whether the advertisement under study was displayed to the user; and
processing the elicited indications for the plurality of particular users includes, for each particular user, processing the persisted indication of that user to determine whether the advertisement under study was displayed to that user and processing the elicited indications from that user based on the determination.

5. The method of claim 4, wherein:
the persisted indication of that user includes an indication of the information that is substantially independent of the actions by the particular users, upon which the step of selectively causing display of the advertisement under study was based.

6. The method of claim 1, wherein:
the method further comprises, for each of the particular users, based on the action by that particular user corresponding to the advertisement under study, saving a browser cookie that includes information usable to determine whether the advertisement under study was displayed to the user; and
processing the elicited indications for the plurality of particular users includes, for each particular user, processing the browser cookie to determine whether the advertisement under study was displayed to that user and processing the elicited indications from that user based on the determination.

7. The method of claim 1, wherein:
eliciting from that user indications relative to the subject matter of the advertisement under study includes
causing a browser of the user to display a page that includes an invisible advertisement, wherein the browser processes the invisible advertisement to cause a survey invitation to be launched.

8. The method of claim 1, further comprising:
determining that a user, generally, is one of the particular users, wherein the determination is used to determine from which users to elicit indications relative to the subject matter of the advertisement under study.

9. The method of claim 1, wherein:
the action by that particular user includes providing a search query that correspond to the advertisement under study.

10. The method of claim 1, wherein:
the action by that particular user includes causing a browser to display a page whose content includes keywords that correspond to the advertisement under study.

11. The method of claim 1, wherein:
the step of processing the elicited indication includes generating a statistical representation of the attitudes of the particular users, generally, with respect to the subject matter of the advertisement under study.

12. A computing device operable to perform the method of claim 1.

13. A system configured for displaying information and accompanying advertising material, comprising:
a plurality of client computers, each configured to provide a signal indicative of a user action;
a display generator configured to process the signals indicative of the user actions and to cause, based on a particular signal provided from a particular client computer, the display of information, by that particular client computer, relevant to the particular user action of which that particular signal is indicative and to also cause display of advertising material relevant to the displayed information;
wherein the display generator is configured to select between display of advertising material under study and other advertising material, wherein the selection is based on information that is substantially independent of the particular user action and of the client computer that provided the particular signal, indicate of the user particular user action, such that the advertisement under study is caused to be displayed by some of the client computers and is not caused to be displayed by some of the client computers; and
a survey processor, configured to receive indications of the users relative to subject matter of the advertisement under display and to process the received indications to analyze the effect, collectively, of the advertisement under study.

14. A computer program product to study effects on users of an advertisement under study, wherein actions by the users result in displaying information corresponding to the actions of the users and of advertisements corresponding to the actions by the user and/or to the displayed information, comprising at least one computer-readable medium having computer program instructions stored therein which are operable to cause at least one computing device to:
for each of a plurality of particular users,
in response to a display event resulting from action by that particular user, corresponding to the advertisement under study, cause display to that particular user of the information corresponding to that action;
selectively cause the advertisement under study to be displayed to that particular user in association with the information corresponding to that action, based on information that is substantially independent of that action and of the particular user;
at a time later than the time at which the information is caused to be displayed to that particular user, elicit from that particular user indications relative to the subject matter of the advertisement under study;
process the elicited indications for the plurality of particular users to analyze the effect, collectively, of the advertisement under study.

15. The computer program product of claim 14, further comprising computer program instructions operable to cause the at least one computing device to:
modify a configuration substantially independently of the actions of the particular users;
wherein the information upon which selectively causing the advertisement under study to be displayed includes the configuration being modified.

16. The computer program product of claim 15, wherein:
the configuration is a keyword bidding configuration, that associates an advertisement for display with the keywords corresponding to the advertisement under study.

17. The computer program product of claim 14, wherein:
the computer program product further comprising computer program instructions operable to cause the at least one computing device to, for each of the particular users, based on the action by that particular user corresponding to the advertisement under study, persist an indication of that user, including information usable to determine whether the advertisement under study was displayed to the user; and
processing the elicited indications for the plurality of particular users includes, for each particular user, processing the persisted indication of that user to determine whether the advertisement under study was displayed to that user and processing the elicited indications from that user based on the determination.

18. The computer program product of claim 17, wherein:
the persisted indication of that user includes an indication of the information that is substantially independent of the actions by the particular users, upon which selectively causing display of the advertisement under study was based.

19. The computer program product of claim 14, wherein:
the computer program product further comprising computer program instructions operable to cause the at least one computing device to, for each of the particular users, based on the action by that particular user corresponding to the advertisement under study, save a browser cookie that includes information usable to determine whether the advertisement under study was displayed to the user; and
processing the elicited indications for the plurality of particular users includes, for each particular user, processing the browser cookie to determine whether the advertisement under study was displayed to that user and processing the elicited indications from that user based on the determination.

20. The computer program product of claim 14, wherein:
eliciting from that user indications relative to the subject matter of the advertisement under study includes
causing a browser of the user to display a page that includes an invisible advertisement, wherein the browser processes the invisible advertisement to cause a survey invitation to be launched.

21. The computer program product of claim 14, further comprising computer program instructions operable to cause the at least one computing device to:
determine that a user, generally, is one of the particular users, wherein the determination is used to determine from which users to elicit indications relative to the subject matter of the advertisement under study.

22. The computer program product of claim 14, wherein:
the action by that particular user includes providing a search query that correspond to the advertisement under study.

23. The computer program product of claim 14, wherein:
the action by that particular user includes causing a browser to display a page whose content includes keywords that correspond to the advertisement under study.

24. The computer program product of claim 14, wherein:
processing the elicited indication includes generating a statistical representation of the attitudes of the particular users, generally, with respect to the subject matter of the advertisement under study.
